(19) United States
(12) Patent Application Publication
(10) Pub. No.: US 2004/0068590 A1
(43) Pub. Date: Apr. 8, 2004

(54) Data processor

(75) Inventors: Tatsuo Nishino, Kodaira (JP); Mamoru Wakabayashi, Kokubunji (JP); Toru Ichien, Higashiyamato (JP)

Correspondence Address: MILES & STOCKBRIDGE PC, 1751 PINNACLE DRIVE, SUITE 500, MCLEAN, VA, 22102-3833, US

(73) Assignees: Renesas Technology Corp.; Renesas Northern Japan Semiconductor, Inc.; Hitachi Device Engineering Co., Ltd.

(21) Appl. No.: 10/665,558

(22) Filed: Sep. 22, 2003

(30) Foreign Application Priority Data
Sep. 24, 2002 (JP) 2002-276564

(51) Int. Cl. G06F 3/00

(52) U.S. Cl. 710/52

(57) ABSTRACT

In this data processor, the semiconductor chip comprises a central processing unit, an interface controller, and a bus controller. The interface controller further includes an interface control unit, a FIFO unit, and a transfer control unit. The interface control unit outputs the data of the FIFO unit to the external side of the semiconductor chip and inputs the data inputted from the external side of the semiconductor chip to the FIFO unit. The transfer control unit performs the control to transfer the data stored in the FIFO unit by designating the transfer destination address and the control to input the data to the FIFO unit by designating the transfer source address. The control by the data transfer control device is not included in the transfer control by the transfer control device. Accordingly, the time required for the data transfer between the on-chip interface controller and the external side can be curtailed.

### BACKGROUND OF THE INVENTION

The present invention relates to a data processor including an interface controller to input and output data to and from an external device and particularly to the technology which may effectively be adapted, for example, to a microcomputer comprising a USB (Universal Serial Bus) interface controller.

The patent document 1 describes a microcontroller in the periphery of the USB including a DMA (Direct Memory Access) controller. Meanwhile, the patent documents 2 to 7 describe a serial data controller including a DMA controller and a serial/parallel converting circuit. The patent document 8 describes a communication control system including an SCI (Serial Communication Interface) controller and a DMA controller within the communication controller.

The patent document 3 also describes a data transfer controller including a dual address mode. The data transfer controller described in this patent document also includes an FIFO buffer. Since the FIFO buffer has the buffers in a plurality of stages, it is possible that data can be read continuously from the transfer source address and is then stored in the FIFO in the upper limit of the number of stages of buffer in the dual address mode and this stored data can be continuously written into the transfer destination address. In this dual address mode, it is also permitted that the read and write processes are not performed alternately. Therefore, the data transfer efficiency can be improved for a device, as represented by the SDRAM (Synchronous DRAM), which enables continuous data input and output operations such as a burst access for making continuous access to the memory cell used in common for the row address through the sequential switching of the column address.

[Patent Document 1]

Japanese Published Unexamined Patent Application No. 326251/1998

[Patent Document 2]

Japanese Published Unexamined Patent Application No. 165551/1992

[Patent Document 3]

Japanese Published Unexamined Patent Application No. 168555/1992

[Patent Document 4]

Japanese Published Unexamined Patent Application No. 350752/1992

[Patent Document 5]

Japanese Published Unexamined Patent Application No. 255054/1992

[Patent Document 6]

Japanese Published Unexamined Patent Application No. 225455/1992

[Patent Document 7]

Japanese Published Unexamined Patent Application No. 289979/1993

[Patent Document 8]

Japanese Published Unexamined Patent Application No. 154977/2001

### SUMMARY OF THE INVENTION

The inventors of the present invention have discussed an interface controller of the USB or the like. The interface controller includes the one comprising a FIFO buffer as the buffer to temporarily store the transmitting and receiving data. Data transfer between the FIFO buffer and memory may be performed with a DMA controller. In order to improve the data transfer efficiency with the DMA controller, it is enough to introduce a structure including the FIFO buffer as described in the Patent Document 8. In the case of transferring the receiving data to the memory from the interface controller by introducing such interface controller and the DMA controller, the DMA controller instructs the FIFO buffer of the interface controller to continuously output the receiving data to the bus in the predetermined unit, sequentially stores the output data to the FIFO buffer in the DMA controller, sequentially outputs the data stored from the FIFO buffer in the DMA controller and then controls the write operation to the memory by outputting the transfer destination memory address.

However, in this case, it is required to move the data to the FIFO buffer in the DMA controller from the FIFO buffer in the interface controller and therefore the serial process is performed. Even when the transfer direction is inverted, the similar process is also performed. Namely, the data to be transferred is once moved to the FIFO buffer in the DMA controller from the transfer source and is then given to the interface controller. As is obvious from above description, the inventors of the present invention have proved that the transfer efficiency must further be improved even when the DMA controller is provided with the FIFO buffer in order to continuously improve the data transfer efficiency.

It is therefore an object of the present invention to provide a data processor which can curtail the data transfer time between an on-chip interface controller and an external device.

The aforementioned and the other objects and the novel features of the present invention will become apparent from the description of this specification and the accompanying drawings thereof.

The typical inventions of the present invention disclosed in this specification can be briefly described as follows.

[1] A data processor comprises, over a semiconductor chip, a central processing unit, an interface controller to input and output the data from and to the external device of the semiconductor chip, and a bus controller which may be connected to an external bus. The interface controller includes an interface control unit, an FIFO unit, and a transfer control unit. The interface control unit outputs the data of the FIFO unit to the external side of the semiconductor chip and inputs the data inputted from an external side of the semiconductor chip to the FIFO unit. The transfer control unit controls the transfer of data stored in the FIFO unit with designation of the transfer destination address and also controls the input of data to the FIFO unit with designation of the transfer source address. The transfer control by the transfer control unit does not include the control by a general purpose data transfer control device.

According to the means described above, the FIFO unit is provided in common for the interface control unit and the transfer control unit. In summary, a buffer of the general purpose DMA controller provided between the transfer source and transfer destination is used in common with the FIFO buffer of the interface controller provided as one transfer source and the transfer destination to enable as if the data were transferred in direct to the transfer destination from the transfer source. It does not mean that the DMA controller is used exceptionally only for the interface controller. The FIFO unit also operates as the buffer of the interface control unit and therefore the read from the transfer source and write to the transfer destination can be realized within the unit access cycle. This is different from only the single addressing mode provided with the DMA controller. While the transfer destination address is designated, the data to be transferred can be outputted continuously from the FIFO unit and while the transfer source address is designated, the data to be transferred can be inputted to the FIFO unit. Accordingly, the time required for data transfer between the on-chip interface controller and the external side can be reduced.

According to a typical aspect of the present invention, the transfer control unit designates, in parallel to the read operation of data from the FIFO unit, the transfer destination address to store the data. Moreover, according to another aspect of the present invention, the transfer control unit inputs, in parallel to the read operation of data from the designated transfer source address, the data to the FIFO unit.

The interface controller is, for example, a USB interface controller.

[2] The data processor eliminates, according to the different aspect, the transfer control unit from the view point of the interface controller for this data processor and introduces, in place of such transfer control unit, the data transfer control device for the interface controller. The data transfer control device for interface controller performs the control to transfer the data stored in the FIFO unit by designating the transfer destination address and the control to input the data to the FIFO unit by designating the transfer destination address. In these control operations, the data is not transferred via the general purpose data transfer control device.

According to the practical aspect, the data transfer control device for interface controller designates, in parallel to the read operation of data from the FIFO unit, the transfer destination address to store the data. According to another aspect, the data transfer control device for interface controller inputs, in parallel to the read operation of data from the designated transfer destination address, the data to the FIFO unit.

[3] According to another aspect, the data processor eliminates the FIFO unit from the view point of the interface controller and utilizes, in place of such FIFO unit, a part of the region of the on-chip RAM as the FIFO buffer. In this case, the interface control unit outputs the data stored in the predetermined region of the RAM to the external side of the semiconductor chip with the predetermined protocol and inputs the data inputted with the predetermined protocol from the external side of the semiconductor chip to the predetermined region of RAM. The transfer control unit performs the control to transfer the data stored in the predetermined region of the RAM by designating the transfer destination address and the control to input the data to the predetermined region of the RAM by designating the transfer destination address.

Restriction on the upper limit in the number of stages of buffers may be alleviated in comparison with the FIFO unit by utilizing the on-chip RAM for the FIFO buffer.

According to the practical aspect, the transfer control unit is individually provided with a first address generating unit to generate the address for making access to the predetermined region of RAM in the FIFO format and a second address generating unit to generate the address for making access via an external bus by way of the bus controller. In this case, the transfer control unit reads, in the former half of the transfer cycle, the data from the address designated with the first address generating unit and then writes, in the latter half of the transfer cycle, the data to the address designated with the second address generating unit.

[4] According to another aspect of the present invention, the data processor comprises a CPU, a USB controller, a DMA controller, and an internal bus coupled with the CPU, USB controller and DMA controller. The USB controller includes a FIFO buffer and a data transfer control device which can realize the transfer control of data stored in the FIFO buffer. For example, the data transfer control device has the address generating function which can designate the address of the FIFO buffer and the address of an external device to be coupled with the data processor.

According to another aspect of the present invention, the data processor comprises a CPU, a USB controller, a DMA controller, a RAM, and an internal bus coupled with the CPU, USB controller, DMA controller and RAM. The USB controller also includes a data transfer control device which can execute transfer control of data stored in the RAM. For example, the data transfer control device has the address generating function to designate the address of RAM and the address of external device to be coupled with the data processor.

According to another aspect of the present invention, the data processor is designed as a data processor provided on a semiconductor chip, and comprises an external device to be coupled with the general purpose external bus via the general purpose external bus coupled with the data processor, a general purpose data transfer control unit which can execute the data transfer, and a data transfer control unit of the predetermined interface which can execute data transfer with an external side of the data processor via the predetermined external bus of the predetermined specification to be coupled with the data processor. The data transfer control unit of the predetermined interface includes an address designating unit which can designate the address of the transfer buffer and the address of external device. The transfer buffer is provided, for example, in the data transfer control unit of the predetermined interface. The data processor further includes a RAM and the transfer buffer may be a part of the region of the RAM. The RAM further includes the region which is considered as the transfer buffer, for example, for the general purpose data transfer control unit. The address designating unit reads, for example, in the former half of the transfer cycle, the data from the designated address and writes, in the latter half of the transfer cycle, the data to the designated address.

### BRIEF DESCRIPTION OF THE DRAWINGS

FIG. 1 is a block diagram illustrating details of a USB interface controller and a bus controller.

FIG. 2 is a block diagram schematically illustrating an entire part of a data processor in relation to an example of a data processor.

FIG. 3 is a timing chart illustrating the data transfer operation to an SDRAM from a FIFO unit with the USB interface controller.

FIG. 4 is a timing chart illustrating the data transfer operation to the FIFO unit from the SDRAM with the USB interface controller.

FIG. 5 is a timing chart illustrating the data transfer operation as a comparison example for data block transfer using a DMAC comprised in a data buffer described in the patent document 8 when the data transfer to the SDRAM from the FIFO unit is performed using the general purpose DMAC.

FIG. 6 is a timing chart illustrating the data transfer operation as a comparison example for data block transfer using the DMAC comprised in the data buffer described in the patent document 8 when the data transfer to the FIFO unit from the SDRAM is performed using the general purpose DMAC.

FIG. 7 is a block diagram illustrating another example of the data processor.

FIG. 8 is a block diagram illustrating another example of the data processor.

FIG. 9 is a timing chart illustrating the data transfer operation to the SDRAM from the FIFO area in the structure of FIG. 8.

### DETAILED DESCRIPTION OF THE PREFERRED EMBODIMENTS

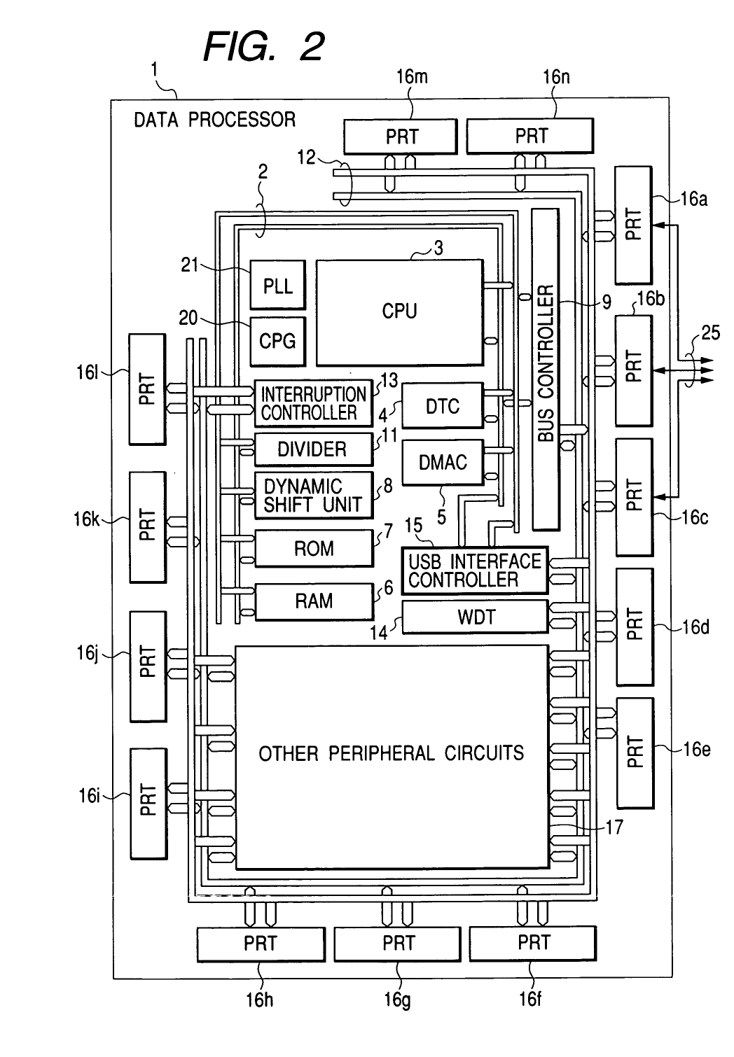

FIG. 2 schematically illustrates an entire part of a data processor 1 in relation to an example of a data processor. The data processor 1 illustrated in FIG. 2 is formed on a semiconductor substrate (semiconductor chip) such as a single crystal silicon, for example, with the CMOS integrated circuit manufacturing technology. Although not particularly restricted, the data processor 1 is comprised in a peripheral device (for example, printer and scanner or the like) in a computer system such as a PC (Personal Computer) or the like for the control thereof.

The data processor 1 is comprised of a central processing unit (CPU) 3 connected to an internal bus 2, a data transfer controller (DTC) 4, a data transfer control device (DMAC) 5 as a general purpose data transfer control unit, a read only memory (ROM) 7 as a program memory to store the process program of CPU 3, a random access memory (RAM) 6 used as a work region of CPU 3 and used for temporary storage of data, a divider 8, a dynamic shift unit 11, a bus controller 9, and a USB interface controller 15 as the data transfer control unit of the predetermined interface.

The internal bus 2 is interfaced with a peripheral bus 12 via the bus controller 9, and the peripheral bus 12 is connected, as the peripheral circuits, with an interruption controller 13, a watched dog timer (WDT) 14, a USB interface controller 15, input/output ports (PRT) 16a to 16n, and the other peripheral circuit 17 such as a timer counter (TMR) and serial communication interface controller (SCI) or the like. The data processor 1 includes, in addition, a clock generating circuit (CPG) 20 and a PLL circuit 21 or the like. The USB interface controller 15 has the serial interface control function conforming to the predetermined protocol for the USB host and is also given additionally the exclusive DMA transfer control function. In other words, the USB interface controller 15 has the function to execute, for the USB host, data transfer via the predetermined external bus of the predetermined interface specification such as the universal serial bus (USB).

The internal bus 2 and peripheral bus 12 respectively include data bus, address bus and control bus (control signal bus). The peripheral bus 2 is interfaced with the peripheral bus 12 via the bus controller 9 and with an external bus 25 via the input/output ports 16a to 16c. The other input/output ports 16d to 16n operate to provide the function as the external interface buffer or the like for the peripheral circuits.

In the data processor 1, a bus master module is the CPU 3, DTC 4, DMAC 5 and USB interface controller 15. The CPU 3 comprises an instruction control unit to fetch instructions, for example, from a ROM 5 and decode the fetched instructions and an execution unit to perform the arithmetic processes using a general purpose register and a logical arithmetic device depending on the instruction decoding result by the instruction control unit. The DMAC 5 initially sets the data transfer condition with the CPU 3 via the internal bus 2 and controls data transfer within the data processor 1 between the internal side and external side of the data processor 1, in response to the data transfer request from the built-in peripheral circuit or external device. The DTC 4 control the data transfer within the data processor 1 or between the internal side and external side of the data processor 1 in response to the data transfer request from the built-in peripheral circuits and external device. The data transfer condition is obtained with reference to the transfer control data of the pointer format stored in the RAM 6 or the like. The USB interface controller 15 includes, although not particularly restricted, the FIFO unit and has the exclusive DMA transfer control function between the FIFO unit and the external side of the data processor 1. The data transfer control condition is set with the CPU 3 via the internal bus 2. An address signal to designate the transfer source and transfer destination with the DMA transfer control function of the USB interface controller 15 is transferred to the external bus 25 via the internal bus 2 and bus controller 9.

When a reset signal is applied to the data processor 1, a on-chip circuit module such as CPU 3 or the like is reset. When the reset condition is cancelled with the reset signal, the CPU 3 reads an instruction from the predetermined start address, starts execution of the program, fetches data, for example, from the RAM 6 depending on the execution of program, performs the arithmetic operation of data fetched and performs the predetermined control of devices such as printer control through data input/output operation for the external devices using the USB interface controller 15 based on the result of processes.

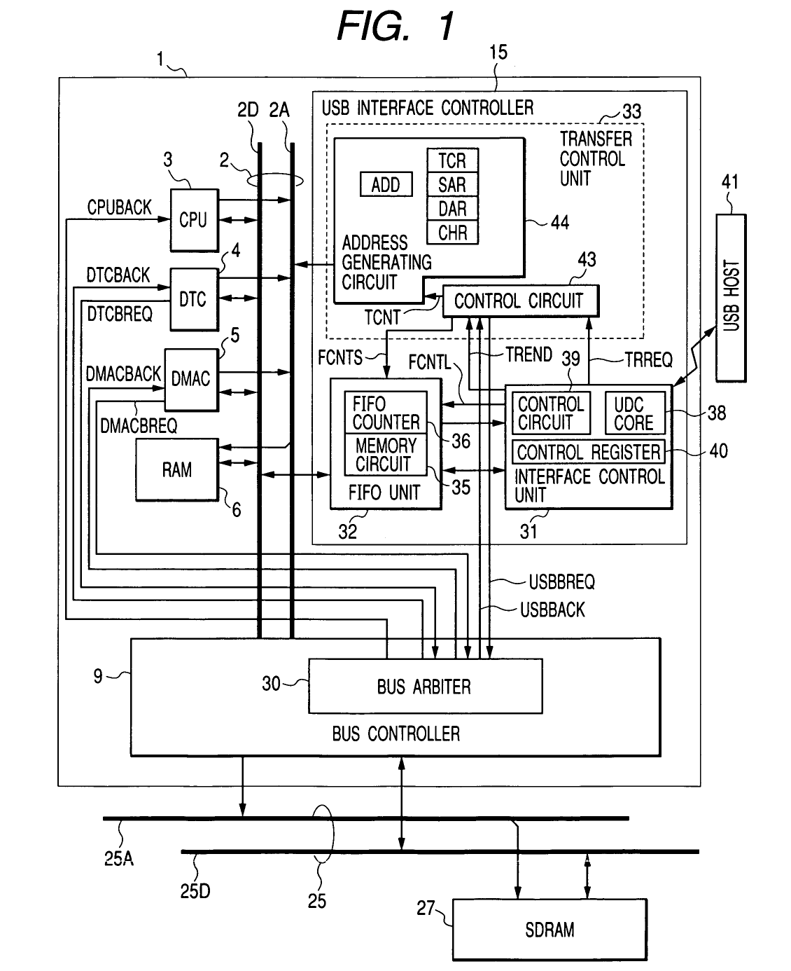

FIG. 1 illustrates details of the USB interface controller 15 and bus controller 9. As the internal bus 2, an internal address bus, a control bus 2A and an internal data bus 2D are illustrated. As the external bus 25, an external address bus, a control bus 25A, and an external data bus 25D are illustrated and these are connected with the typically illustrated SDRAM 27. In the same figure, the peripheral bus 12, input/output ports 16a to 16n and a part of the other circuit modules are not illustrated.

The bus controller 9 mediates with a bus arbiter 30, the competition for the bus right requests among the CPU 3, DMAC 5, DTC 4 and USB interface controller 15 as the bus master module. Actually, the bus right request by the external bus master is also considered but the external bus master is not considered here to simplify the description. The USBBREQ, DMACBREQ, DTCBREQ are bus right request signals, and the USBBACK, BACK2, DMACBACK, DTCBACK and CPUBACK are bus right acknowledgment signals.

The bus arbiter 30 performs mediation to selectively give the bus right to the bus right request signals (DTCBREQ, DMACBREQ, USBBREQ) from the bus master module (DTC 4, DMAC 5, USB interface controller 15) other than the CPU 3. The bus master module which has asserted the bus right request signal recognizes acquisition of bus right and starts use of the bus, upon assertion of the bus right acknowledgment signals BACK1, BACK2, BACK3 returned from the bus arbiter 30. The bus master module which has used the bus negates, upon completion of use of bus, the bus right request signal. The bus arbiter 30 asserts the bus right acknowledgment signal CPUBA to the CPU 3 under the negating condition of all bus right request signals USBBREQ, DMACBREQ, DTCBREQ. Accordingly, the CPU 3 obtains the bus right and processes the data using the bus. Such control realizes the high speed data process by the CPU 3 because the bus arbiter 30 gives the bus right to the CPU 3 with the priority.

Meanwhile, although not illustrated, it is also possible to provide a structure that the bus arbiter 30 outputs a bus right request signal to the CPU 3. In this case, this structure is effective to form a multi-CPU in which the other CPUs are also provided in addition to the CPU 3 within the chip of the data processor. Namely, when the other CPU outputs the bus right request signal to the bus arbiter 30, the bus arbiter 30 outputs the bus request signal to the CPU 3 to release the bus right from the CPU 3. Thereafter, the bus arbiter 30 gives the bus right by outputting the bus right acknowledgment signal to the other CPU. When the data process of the other CPU has completed, the bus arbiter 30 asserts the bus right acknowledgment signal CPUBACK to the CPU 3. Thereby, the bus right is returned to the CPU 3. In this case, since the bus right can selectively be given to the other CPUs, the data process of the CPU 3 and the data process of the other CPU may be controlled effectively.

The bus master module which is given the bus right with mediation by the bus arbiter 30 outputs a bus command such as the address signal and access control signal to the bus 2A. The bus controller 9 determines, based on the contents of the bus command, the number of access cycles and data width or the like to perform the bus access control and memory access control, etc. For the bus access control and memory access control or the like, the information such as access data size and access speed of the device which is mapped for every address area are initially set with the CPU 3 immediately after the power-ON reset and the bus control (output of device address, data access size, insertion of wait state, or the like) for the external bus is performed depending on the area of access address supplied from the internal address bus and control bus 2A or the like.

The USB interface controller 15 includes an interface control unit 31, a FIFO unit 32 and a transfer control unit 33.

The FIFO unit 32 is formed of a memory circuit 35 and a FIFO counter 36. The memory circuit 35 is formed of a plurality of memory stages which can input and output the data in the data width depending on the number of bits of the data bus 2D. The FIFO counter 36 is configured with a read pointer which designates the number of memory stages in response to the read operation instruction and a write pointer which designates the number of memory stages in response to the write operation instruction. The read pointer is composed of a ring counter for read operation of the number of bits corresponding to the number of memory stages, while the write pointer is composed of a ring counter for write operation of the number of bits corresponding to the number of memory stages.

The interface control unit 31 is composed of a UDC (USB device control) core 38, a control circuit 39, and a control register 40. The UDC core 38 is connected to a USB host 41 mounted to a personal computer via using a USB cable and performs the serial transmission and reception control of data with the predetermined protocol in response to the command from the USB host 41. The receiving data from the USB host 41 is sent to the FIFO unit 32 and the transmitting data to the USB host 41 is supplied from the FIFO unit 32. The control circuit 39 performs the read/write control to the FIFO unit 32 and the transfer request control to the transfer control unit 33.

The read/write control of the FIFO unit 32 with the interface control unit 31 is executed to give the read request or write request to the FIFO unit 32 with the control signal FCNTL. Accordingly, the FIFO unit 32 reads, when the read request is given, the stored information in the memory stages instructed with the read pointer to the interface control unit 31 and stores, when the write request is given, the information from the interface control unit 31 to the memory stages instructed with the write pointer.

The transfer request control to the transfer control unit 33 with the interface control unit 31 includes the DMA transfer request instructed with the control signal TRREQ in response to the empty/full condition of the FIFO unit 32, and the DMA transfer end request instructed with the control TREND. For example, when the FIFO unit 32 is in the full condition during the receiving operation from the USB host 41, a request to transfer the data of FIFO unit 32 to the SDRAM 27 is issued and when the FIFO unit 32 is in the empty condition during the transmitting operation to the USB host 41, a request to transfer the data to the FIFO unit 32 from the SDRAM 27 is issued. The interface control unit 31 discriminates the empty and full conditions with reference to a value of the FIFO counter 36 during the transmitting and receiving operation of data. When the full condition of the FIFO unit 32 is changed to the empty condition with the data transfer to the SDRAM 27 in the receiving operation, it is instructed to end the DMA transfer. Moreover, when the empty condition of the FIFO unit 32 is changed to the full condition with the data transfer to the FIFO unit 32 in the transmitting operation, it is instructed to end the DMA transfer.

The transfer control unit 33 includes a control circuit 43 and an address generating circuit 44. The address generating circuit 44 generates an address of the SDRAM 27 which is any one of the transfer source and transfer destination for the data transfer. For generation of address, the address generating circuit 44 includes a transfer number register TCR for counting the number of times of transfer, a source address register SAR for generating the transfer source address, a destination address register DAR for generating the transfer destination address and a control register CHR for holding the transfer control information and the counting operation is performed with an adder ADD through increment and decrement of the registers SAR, DAR and TCR for every transfer operation. Accordingly, the DMA transfer control is performed. The initial setting of the registers SAR, DAR, TCR and CHR is performed with the CPU 3.

The control circuit 43 performs the bus right control for the bus controller 9, access address generation control of SDRAM 27 with the address generating unit 44 and read/writer control from the side of bus 2 for the FIFO unit 32 in response to the DMA transfer request by the signal TRREQ and the DMA transfer end request by the signal TREND.

First, as the bus right control, the control circuit 43 asserts, when the DMA transfer request is issued with the signal TRREQ from the interface control unit 31, the signal USBBREQ to the bus arbiter 30 and obtains the bus right when the assertion of signal USBBACK is returned. Upon acquisition of the bus right, the necessary DMA transfer control is performed and the signal SBBREQ is negated when the transfer is terminated. Thereby the bus right can be cancelled.

When the bus right is acquired, the control circuit 43 performs the access address generation control of the SDRAM 27 and the read/write control for the FIFO unit. When transfer of data to the SDRAM 27 from the FIFO unit 32 is requested with the signal TRREQ, the data is outputted to the bus 2D from the FIFO unit 32 by controlling the read pointer of the FIFO unit 32 with the signal FCNT and an instruction of write operation to the SDRAM 27 and a write address are outputted to the bus 2A from the address generating unit 44 in parallel to such data output. When transfer of data to the FIFO unit 32 from the SDRAM 27 is requested with the signal TRREQ, the instruction for read operation to the SDRAM 27 and read address are outputted to the bus 2A from the address generating unit 44 in order to read the data to the bus 2D. Moreover, the data of bus 2D is written to FIFO unit 32 by controlling the write pointer of the FIFO unit 32 with the signal FCNT in parallel to such data read operation.

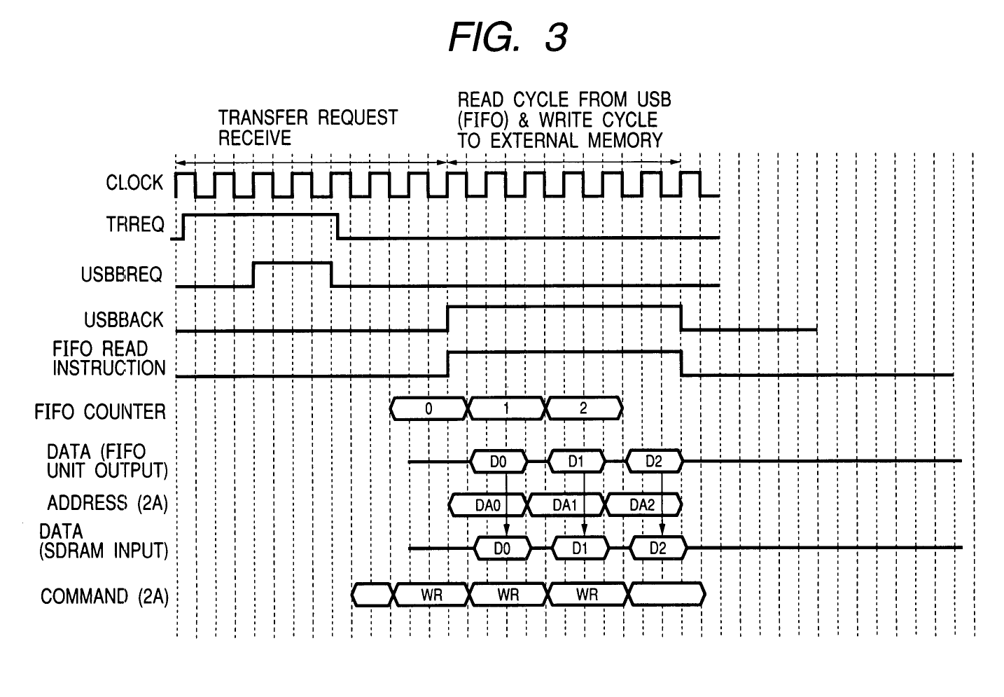

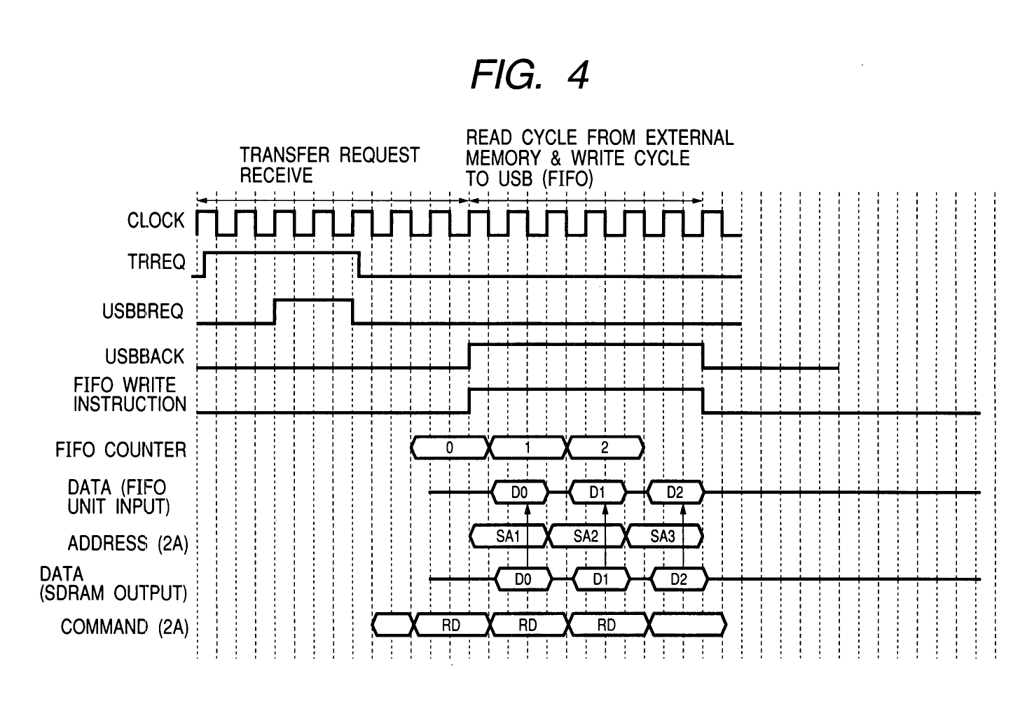

FIG. 3 illustrates the timing of the data transfer operation to the SDRAM 27 from the FIFO unit 32 with the USB interface controller 15, while FIG. 4 illustrates the timing of the data transfer operation to the FIFO unit 32 from the SDRAM 27 with the USB interface controller 15. With reference to these figures, the transmitting and receiving operations of the USB interface controller 15 will be described.

When the data is transferred from the USB host 41 via the USB cable, this data is sequentially stored in the FIFO unit 32. When the FIFO unit 32 becomes full condition, the interface control unit 31 outputs (TRREQ assertion in FIG. 3), to the transfer control unit 33, the transfer request to the SDRAM 27 from the FIFO unit 32 with the signal TRREQ.

The control circuit 43 of the transfer control unit 33 in response to this transfer request requests the bus right by asserting the signal SBBREQ to the bus arbiter 30 (USBBREQ assertion in FIG. 3). The bus arbiter 30 mediates the bus right and gives the bus right to the USB interface controller 15 by asserting the signal USBBACK (USBBACK assertion in FIG. 3). Upon acquisition of the bus right, the control circuit 43 controls the FIFO unit 32 with the signal FCNT to control the FIFO unit 32 to output the data to the data bus 2D. Moreover, the control circuit 43 controls the address generating unit 44 with the signal TCNT to output the transfer destination address of the SDRAM 27 and the write control signal to the address bus and control bus 2A. The read operation with the address of the read pointer of the FIFO unit 32 and the write operation with the address of the register DAR of the address generating circuit 44 are performed in parallel, address increments in both operations are also synchronized with the control circuit 42 and the receiving data is transferred to the SDRAM 27 through repetition of the data transfer operations for the predetermined number of times. In FIG. 3, a value of the FIFO counter 36 is incremented to 0, 1, 2, the data D0, D1, D2 having the addresses of these values are outputted to the bus 2D from the FIFO unit 32, the addresses DA0, DA1, DA2 of the SDRAM 27 are sequentially outputted to the bus 2A in parallel to such data output, and thereby the data D0, D1, D2 of the bus 2D are sequentially written into the SDRAM 27.

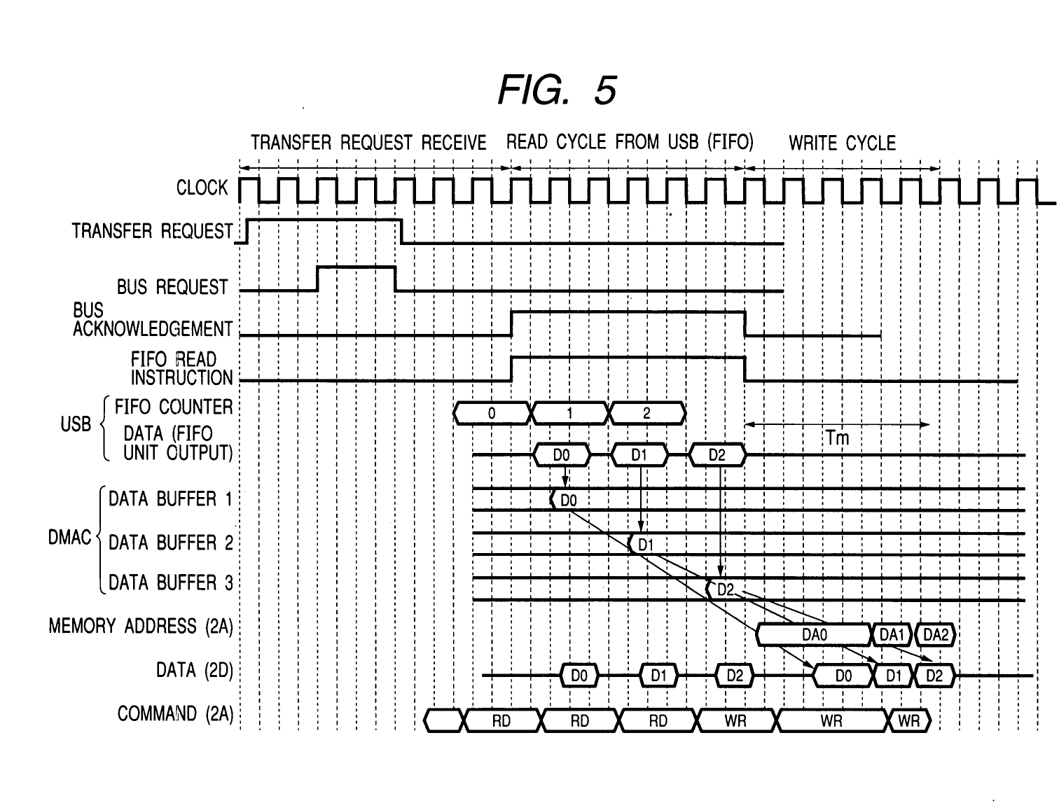

For example, when the data transfer to the SDRAM 27 from the FIFO unit 32 is performed, as a comparison example, using the general purpose DMAC 5, even if the data block transfer is executed using the DMAC comprised in the data buffer described in the patent document 8, the transfer operation to the data buffer of the DMAC 5 from the FIFO unit 32 is performed in serial to the transfer operation to the SDRAM 27 from the data buffer of DMAC 5. Thus, the transfer operation period becomes longer. As the operation timing of FIG. 3, the transfer operation time can be curtailed only by the time Tm for FIG. 5.

On the other hand, in the transmission process to the USB host 41, when the data in the FIFO unit 32 becomes empty, a transfer request to the FIFO unit 32 from the SDRAM 27 is issued with the signal TRREQ to the control circuit 43 of the transfer control unit 33 from the interface control unit 31 (TRREQ assertion in FIG. 4).

The control circuit 43 of the transfer control unit 33 responding to this transfer request requests the bus right by asserting the signal USBBREQ to the bus arbiter 30 (USBBREQ assertion in FIG. 4). The bus arbiter 30 mediates the bus right and gives the bus right to the USB interface controller 15 by asserting the signal USBBACK (USBBACK assertion in FIG. 4). When the bus right is obtained, the control circuit 43 controls the address generating circuit 44 with the signal TCNT to output the transfer source address of the SDRAM 27 and the read control signal to the address bus and control bus 2A. Moreover, the control circuit 43 controls the FIFO unit 32 with the signal FCNT to input the data of the data bus 2D to the FIFO unit 32. The write operation by the address of the write pointer of the FIFO unit 32 is executed in parallel to the read operation by the address of the register SAR of the address generating circuit 44, address increments of both operations are synchronized with the control circuit 43, the resultant data transfer operations are repeated for the predetermined number of times and thereby the transmitting data is transferred to the FIFO unit 32 from the SDRAM 27. In FIG. 4, the addresses SA0, SA1, SA2 of the SDRAM 27 are sequentially outputted to the bus 2A, the data D0, D1, D2 are thereby sequentially outputted to the bus 2D from the SDRAM 27, a value of the FIFO counter is incremented, for example, to 0, 1, 2 in parallel to such output operation, and the data D0, D1, D2 of the bus 2D are inputted to the FIFO unit 32 using the incremented values as the addresses.

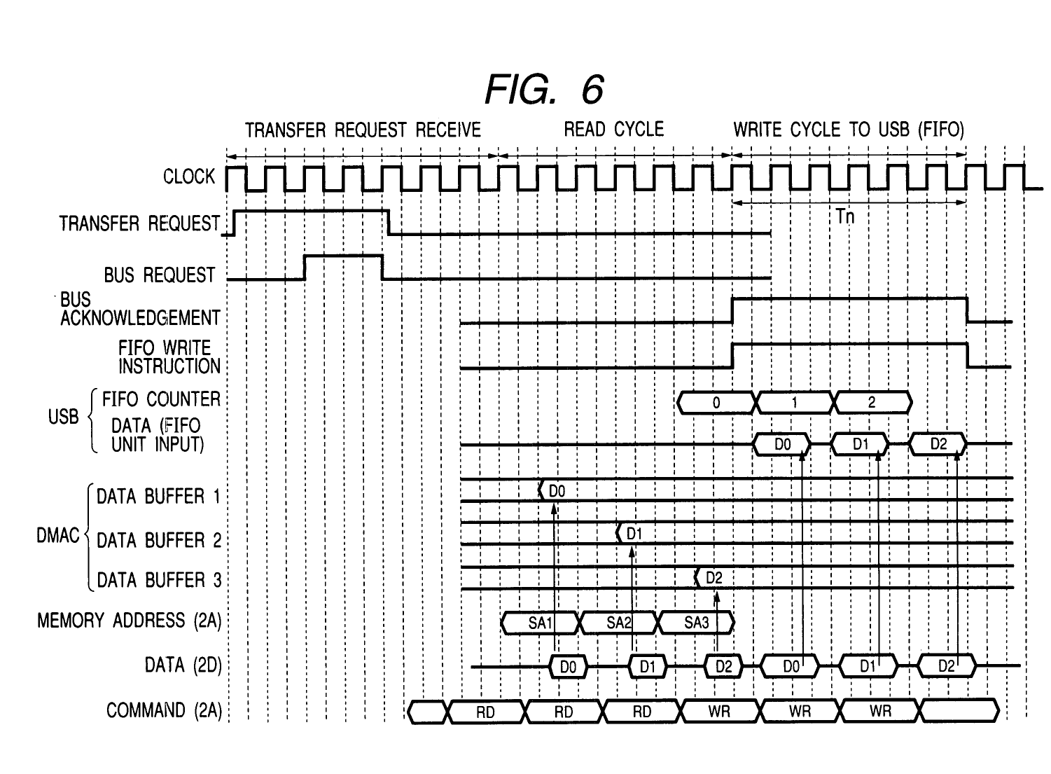

When the data transfer to the FIFO unit 32 from the SDRAM 27, for example, is performed, as a comparison example, using the general purpose DMAC 5, even if the data block transfer is executed using the DMAC built in the data buffer described in the patent document 8, the transfer operation to the data buffer of the DMAC 5 from the SDRAM 27 is performed in serial to the transfer operation to the FIFO unit 32 from the data buffer of the DMAC 5 as illustrated in FIG. 6 illustrating the relevant comparison example. Thus, the time required for the transfer operation becomes longer. With regard to the operation timing of FIG. 4, the transfer operation time may be curtailed only by the time Tn for that of FIG. 6.

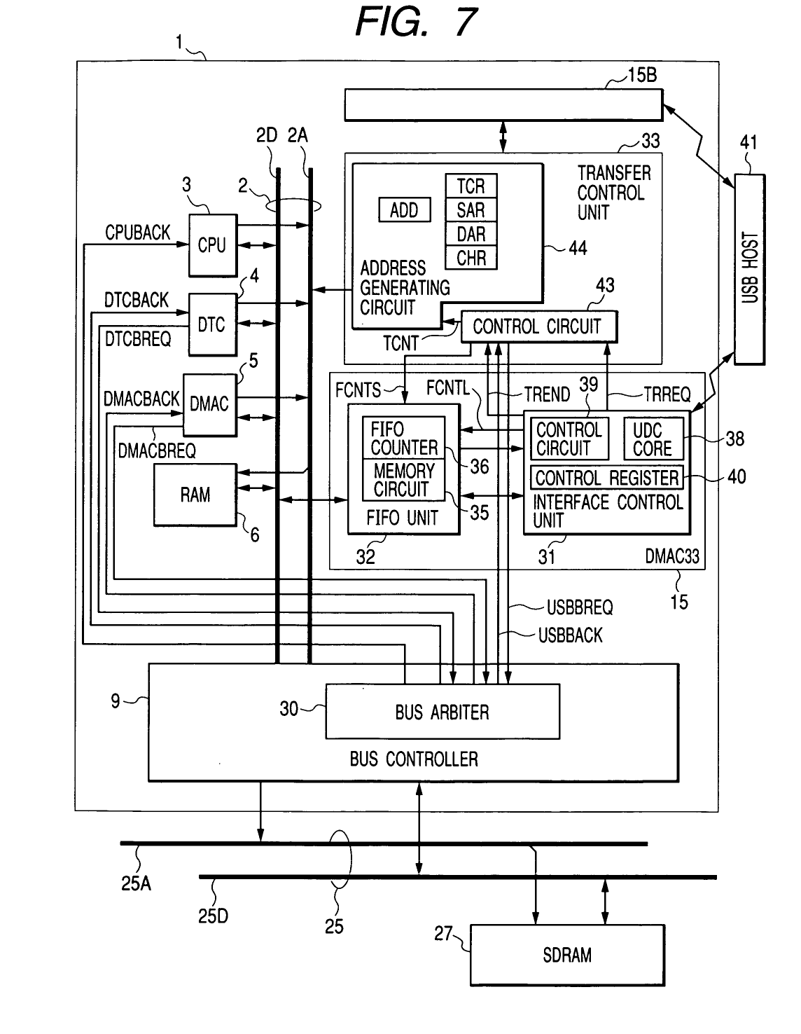

FIG. 7 illustrates another example of the data processor. The data processor illustrated in this FIG. 7 is provided with the transfer control unit 33 independent of the USB interface controller 15. In this case, the control circuit 43 of the transfer control unit 33 is selectively capable of performing the DMA transfer control for a plurality of USB interface controllers 15, 15B. In summary, when a plurality of USB interface controllers are mounted with the on-chip method, the transfer control unit 33 may be used in common for these controllers. Accordingly, this structure contributes to reduction in size of the circuit. Moreover, the similar data transfer control may be realized even for the USB interface controller allocated at the external side of the data processor. Otherwise, the transfer control unit 33 may also be corrected easily even when the specifications of the USB interface are changed due to the update of version.

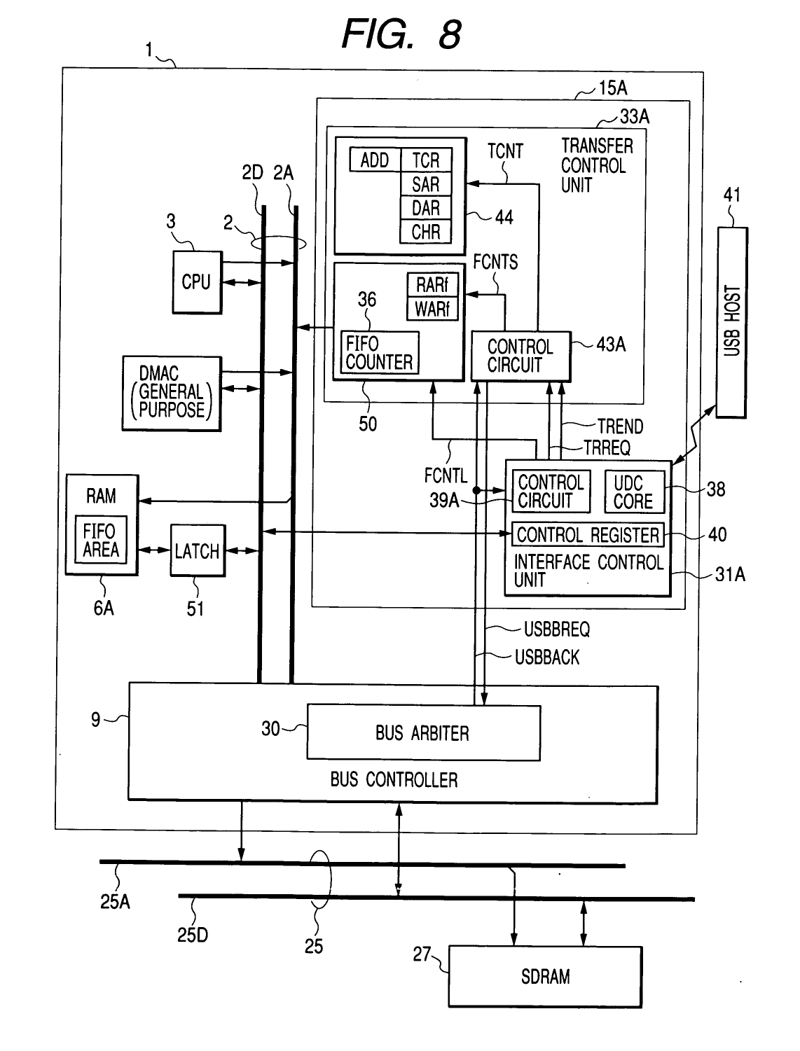

FIG. 8 illustrates another example of the data processor. The USB interface controller 15A illustrated in this FIG. 8 uses a part of the storage region (FIFO area) 6A of the RAM 6 as a storage circuit of the FIFO unit 32 of FIG. 1.

The transfer control unit 33A is provided with an address generating unit 50 of the FIFO area 6A depending on the change of specifications. The address generating unit 50 includes a FIFO counter 36, a read address register RARf for access to the FIFO area 6A, and a write address register WARf. The FIFO unit 36 has the number of bits corresponding to the number of memory stages of the FIFO area 6A and forms the read pointer and write pointer described above. As the initial values of the read address register RARf and write address register WARf, the leading address of the FIFO area 6A is initially set with the CPU 3. The lower digit address of the read address register RARf is replaced with a value of the read point of the FIFO counter 36. The lower digit address of the write address register WARf is replaced with a value of the write pointer of the FIFO counter 36.

Moreover, the interface control unit 31A has to perform the control to obtain the bus right, during the transmitting and receiving process to and from the USB host 41, from the timing of making access to the FIFO area 6A. Namely, for the purpose of transmission and reception with the USB host 41, the interface control unit 31A issues a transfer request for read/write of the FIFO area 6A to the transfer control unit 33A with the signal TRREQ and the transfer control unit 33A issues the bus right request with the signal USBBREQ to obtain the bus right with assertion of the signal USBBACK. Acquisition of the bus right is also notified to the interface control unit 31A and thereby the interface control unit 31A controls the address generating unit 50 to execute the FIFO counting operation in view of writing the receiving data to the FIFO area 6A and reading the transmitting data from the FIFO area 6A. As described above, the interface control unit 31A monitors based on the value of the FIFO counter 36 whether the FIFO area is in the full condition or in the empty condition. When the full condition is detected in the receiving operation, the data transfer to the SDRAM 27 from the FIFO area 6A is requested to the control circuit 43A of the transfer control unit 33A with the signal TRREQ. Thereby, the address generating unit 50 outputs the read address of the FIFO area 6A and an address generating unit 44 generates a write address of the SDRAM 27 to control the DMA transfer described above. When the empty condition is detected during the transmitting operation, the data transfer to the FIFO area 6A from the SDRAM 27 is requested to the transfer control unit 33A with the signal TRREQ. Thereby, the address generating unit 44 outputs the read address of the SDRAM 27 and the address generating unit 50 outputs the write address of the FIFO area 6A to control the DMA transfer operation described above.

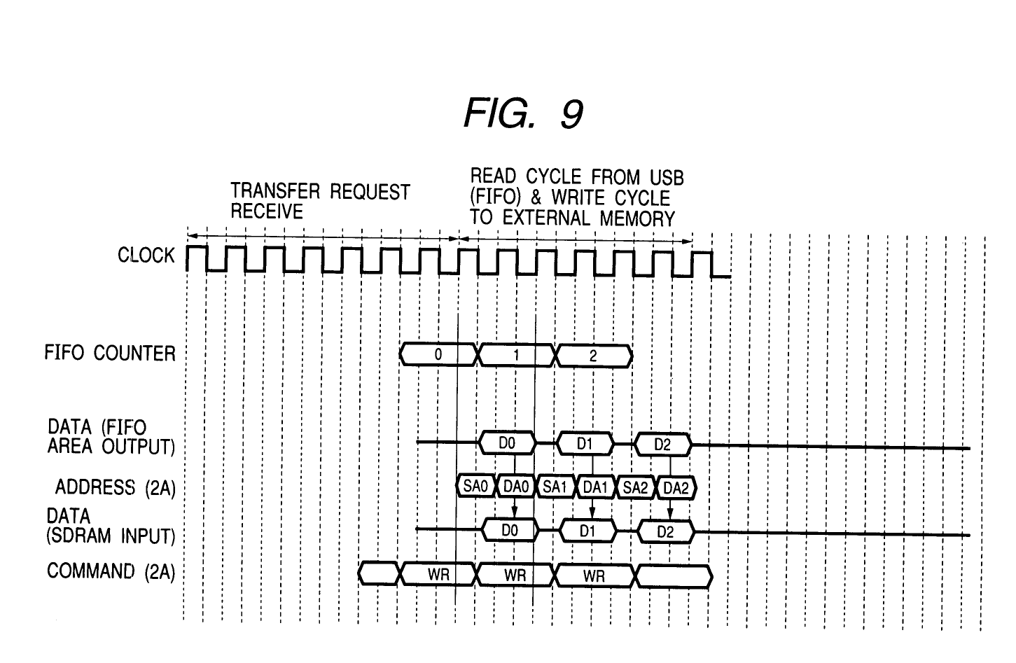

FIG. 9 illustrates the data transfer timing to the SDRAM 27 from the FIFO area 6A in the structure of FIG. 8. In this FIG. 9, a value of the FIFO counter is incremented, for example, to 0, 1, and 2, and the data D0, D1, D2 are outputted to the bus 2D from the FIFO area 6A having these data as the address. In the former half of each memory cycle of this output operation, the read addresses SA0, SA1, SA2 for the FIFO area 6A are outputted to the bus 2A, while in the latter half cycle, the write addresses DA0, DA1, DA2 for the SDRAM 27 are outputted. Accordingly, the data D0, D1, D2 outputted to the bus 2D are written to the SDRAM 27 in the same memory cycle. Although not particularly restricted, even in the data transfer to the FIFO area 6A from the SDRAM 27, the read from the SDRAM and write access to the FIFO area 6A can be realized within one memory cycle as described above.

Restriction for the upper limit in the number of stages of buffer can be alleviated in comparison with the FIFO unit 32 by using a part of the RAM 6 for the FIFO area 6A. Namely, the storage capacity of the FIFO can be rather freely set by varying the number of bits of the FIFO counter 36 of FIG. 8, determining the number of bits of the FIFO counter 36 depending on the number of stages of buffer assigned to the FIFO area 6A, and giving the counted value of the FIFO counter 36 to the lower digits of the registers RAW, RAR.

The present invention has been described practically on the basis of the preferred embodiment thereof but the present invention is never limited thereto and allows various changes and modification within the scope not departing from the claims thereof.

For example, the interface controller is not restricted to the USB interface controller and it may be the other serial interface, parallel interface and moreover the communication controller or communication module or the like. The general purpose data transfer control device is not restricted to that provided with both DMAC and DTC. On the contrary, it is also possible to add the other DMAC. Moreover, a memory connected to the external bus is not limited to the SDRAM and it may be a DRAM, SRAM and a flash memory or the like.

The typical invention of the present invention can provide the following effects.

Namely, the FIFO unit is used in common for the interface control unit and transfer control unit. It does not means that the DMAC controller is exclusively used only for the interface controller. The FIFO unit also operates as a buffer of the interface control unit and therefore it can execute the read operation from the transfer source and write operation to the transfer destination during the unit access cycle. While the transfer destination address is designated, the data to be transferred can be continuously outputted from the FIFO unit and while the transfer source address is designated, the data to be transferred can also be continuously inputted to the FIFO unit. Accordingly, the time required for data transfer between the onchip interface controller and external side can be reduced, realizing much contribution to improvement of data processing efficiency.

What is claimed is:

1. A data processor having a semiconductor chip, comprising:
a central processing unit;
an interface controller to perform input and output of data to and from an external side of the semiconductor chip; and
a bus controller connected with an external bus, wherein said interface controller includes an interface control unit, a FIFO unit, and a transfer control unit,
wherein said interface control unit outputs the data of said FIFO unit to an external side of said semiconductor chip and inputs the data inputted from the external side of said semiconductor chip to said FIFO unit, and
wherein said transfer control unit performs the control to transfer the data stored in the FIFO unit by designating a transfer destination address and the control to input the data to the FIFO unit by designating a transfer source address.

2. The data processor according to claim 1, wherein said transfer control unit designates the transfer destination address for storing the data in parallel to the read of data from said FIFO unit.

3. The data processor according to claim 1, wherein said transfer control unit inputs the data to said FIFO unit in parallel to the read of data from the designated transfer source address.

4. The data processor according to any one of claims 1 to 3, wherein said interface controller is a USB interface controller.

5. A data processor having a semiconductor chip, comprising:
a central processing unit;
an interface controller for inputting and outputting data from and to an external side of the semiconductor chip;
a data transfer control device for interface controller;
a bus controller connected to an external bus; and
a general purpose transfer control device for controlling the data transfer to the external bus via said bus controller,
wherein said interface controller includes an interface control unit and a FIFO unit,
wherein said interface control unit outputs the data of the FIFO unit to the external side of said semiconductor chip and inputs the data inputted from the external side of said semiconductor chip to said FIFO unit, and
wherein said data transfer control device for interface controller performs the control to transfer the data stored in said FIFO unit by designating a transfer destination address and the control to input the data to said FIFO unit by designating a transfer source address.

6. The data processor according to claim 5, wherein said data transfer control device for interface controller designates the transfer destination address for storing the data in parallel to the read of data from said FIFO unit.

7. The data processor according to claim 5, wherein said data transfer control device for interface controller inputs the data to said FIFO unit in parallel to the read of data from the designated transfer source address.

8. A data processor having a semiconductor chip, comprising:
a central processing unit;
an interface controller for inputting and outputting data from and to an external side of the semiconductor chip;
a bus controller connected to an external bus;
a data transfer control device for controlling data transfer to said external bus via said bus controller; and
a RAM,
wherein said interface controller includes an interface control unit and a transfer control unit,
wherein said interface control unit outputs the data stored in a predetermined region of said RAM to the external side of said semiconductor chip and inputs the data inputted from the external side of said semiconductor chip to the predetermined region of said RAM, and
wherein said transfer control unit performs the control to transfer the data stored in the predetermined region of said RAM by designating the transfer destination address and the control to input the data in the predetermined region of said RAM by designating the transfer source address.

9. The data processor according to claim 8, wherein said transfer control unit individually includes a first address generating unit to generate the address for making access in a FIFO format to the predetermined region of said RAM and a second address generating unit to generate the address for making access via the external bus through said bus controller.

10. The data processor according to claim 9, wherein said transfer control unit reads the data from the address designated by said first address generating unit in the former half of a transfer cycle and writes the data to the address designated by said second address generating unit in the latter half of the transfer cycle.

11. A data processor formed over a semiconductor substrate, comprising:
a CPU:
a USB controller;
a DMA controller; and
an internal bus coupled to said CPU, said USB controller, and said DMA controller,
wherein said USB controller includes a FIFO buffer and a data transfer control device which can execute transfer control of the data stored in said FIFO buffer.

12. The data processor according to claim 11, wherein said data transfer control device has an address generating function to designate the address of said FIFO buffer and designate the address of an external device coupled to said data processor.

13. A data processor formed over a semiconductor substrate, comprising:
a CPU;
a USB controller;
a DMA controller;
a RAM; and
an internal bus coupled to said CPU, said USB controller, said DMA controller, and said RAM,
wherein said USB controller includes a data transfer control device which can execute the transfer control of the data stored in said RAM.

14. The data processor according to claim 13, wherein said data transfer control device includes an address generating function to designate the address of said RAM and designate the address of the external device coupled to said data processor.

15. A data processor formed over a semiconductor chip, comprising:
a general purpose transfer control unit which can execute the data transfer for the external device coupled to a general purpose external bus via this general purpose external bus to be coupled to said data processor; and
a data transfer control unit of a predetermined interface which can execute the data transfer for an external side of said data processor via a predetermined external bus having predetermined specifications to be coupled to said data processor,
wherein said data transfer control unit of said predetermined interface includes an address designating unit which can designate the address of transfer buffer and also designate the address of said external device.

16. The data processor according to claim 15, wherein said transfer buffer is provided in the data transfer control unit of said predetermined interface.

17. The data processor according to claim 15, further comprising a RAM,
wherein said transfer buffer is designated as a part of region of said RAM.

18. The data processor according to claim 17, wherein said RAM further includes a region designated as the transfer buffer for said general purpose data transfer control unit.

19. The data processor according to claim 15, wherein said address designating unit reads the data from the designated address in the former half of a transfer cycle and writes the data to the designated address in the latter half of the transfer cycle.
